(19) United States
(12) Patent Application Publication
(10) Pub. No.: US 2026/0061747 A1
(43) Pub. Date: Mar. 5, 2026

(54) LIQUID EJECTION HEAD AND METHOD FOR MANUFACTURING DAMPER UNIT FOR LIQUID EJECTION HEAD

(71) Applicant: CANON KABUSHIKI KAISHA, Tokyo (JP)

(72) Inventor: MAKOTO TAGUCHI, Kanagawa (JP)

(21) Appl. No.: 19/302,335

(22) Filed: Aug. 18, 2025

(30) Foreign Application Priority Data
Aug. 27, 2024 (JP) 2024-145481

(51) Int. Cl. B41J 2/14; B41J 2/16

(52) U.S. Cl. CPC B41J 2/14233; B41J 2/161; B41J 2/1623; B41J 2002/14306

(57) ABSTRACT

A liquid ejection head includes: a plurality of ejection ports; a plurality of pressure chambers configured to communicate with the plurality of ejection ports, respectively; a plurality of pressure generating units installed in the plurality of pressure chambers, respectively, and configured to generate pressure for ejecting the liquid from the ejection ports; a common flow path configured to commonly communicate with the plurality of pressure chambers; a flexible member configured to form a part of a wall surface of the common flow path and configured to be deformable in accordance with pressure fluctuation occurring in the plurality of pressure chambers; and a hollow chamber arranged at a position facing the common flow path via the flexible member, wherein, of the flexible member, a breaking strength at a peripheral portion in the hollow chamber is higher than a breaking strength at a central portion in the hollow chamber.

### BACKGROUND

### Field of the Technology

The present disclosure relates to a liquid ejection head and a manufacturing method thereof.

### Description of the Related Art

Some liquid ejection heads that eject ink are configured to eject ink droplets from ejection ports by applying pressure to the ink in a pressure chamber using a driving unit.

If a pressure fluctuation occurs along with the ejection of ink droplets, this pressure fluctuation may propagate to other pressure chambers via a flow path common to a plurality of ejection ports. In this case, ejection failure due to so-called a crosstalk may occur.

To address this issue, Japanese Patent Laid-Open No. 2022-9224 (referred to as Literature 1) discloses a configuration in which a damper chamber is installed at a position adjacent to a supply/return circulation flow path, and a partition with flexibility is installed between this flow path and the damper chamber. According to such a configuration, since the partition deforms, it is possible to suppress pressure fluctuations of the ink inside the flow path.

The partition described in Literature 1 is also required to have high durability as well as flexibility to function as a damper. However, if priority is given to flexibility, the fixing portion of the partition easily peels off at the time the partition deforms. On the other hand, if priority is given to fastness of the fixing portion, damping performance may be reduced. That is, with the configuration disclosed in Patent Literature 1, there have been cases in which achieving both high damping performance and high durability is difficult.

### SUMMARY

An object of the present disclosure is to provide a liquid ejection head equipped with a damper unit that has high damping performance and high durability.

According to the present disclosure, a liquid ejection head includes: a plurality of ejection ports for ejecting liquid; a plurality of pressure chambers configured to communicate with the plurality of ejection ports, respectively; a plurality of pressure generating units installed in the plurality of pressure chambers, respectively, and configured to generate pressure for ejecting the liquid from the ejection ports; a common flow path configured to commonly communicate with the plurality of pressure chambers; a flexible member configured to form a part of a wall surface of the common flow path and configured to be deformable in accordance with pressure fluctuation occurring in the plurality of pressure chambers; and a hollow chamber arranged at a position facing the common flow path via the flexible member, wherein, of the flexible member, a breaking strength at a peripheral portion in the hollow chamber is higher than a breaking strength at a central portion in the hollow chamber.

According to the present disclosure, high damping performance and high durability of a flexible member are achieved.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of a liquid ejection head of the present disclosure;

FIGS. 2A to 2C are a top view and cross-sectional views describing the structure of a general damper unit in general;

FIGS. 3A to 3C are a top view and cross-sectional views of a damper unit according to the first embodiment of the present disclosure;

FIG. 4 is a schematic cross-sectional view of a damper unit according to the second embodiment of the present disclosure;

FIG. 5 is a schematic cross-sectional view illustrating a modification example of the damper unit according to the second embodiment of the present disclosure;

FIGS. 6A to 6C are a top view and cross-sectional views illustrating a damper unit according to the third embodiment of the present disclosure;

FIG. 7 is a schematic cross-sectional view illustrating a damper unit according to the fourth embodiment of the present disclosure;

FIGS. 8A to 8C are a top view and cross-sectional views illustrating a damper unit according to the fifth embodiment of the present disclosure;

FIGS. 9A to 9E are diagrams illustrating a manufacturing method of the damper unit according to the first embodiment;

FIGS. 10A to 10F are diagrams illustrating a manufacturing method of the damper unit according to the second embodiment;

FIGS. 11A to 11E are diagrams illustrating a manufacturing method of the modification example of the damper unit according to the second embodiment;

FIGS. 12A to 12D are diagrams illustrating a manufacturing method of the damper unit according to the third embodiment;

FIGS. 13A to 13C are diagrams illustrating a manufacturing method of the damper unit according to the fourth embodiment; and

FIGS. 14A to 14E are diagrams illustrating a manufacturing method of the damper unit according to the fifth embodiment.

### DESCRIPTION OF THE EMBODIMENTS

Preferred embodiments of the liquid ejection heads according to the present disclosure are described to explain the configurations, operations, and effects of the present disclosure. Note that, although specific expressions may be used to fully explain the present disclosure, they are not intended to limit the scope.

### (Liquid Ejection Apparatus)

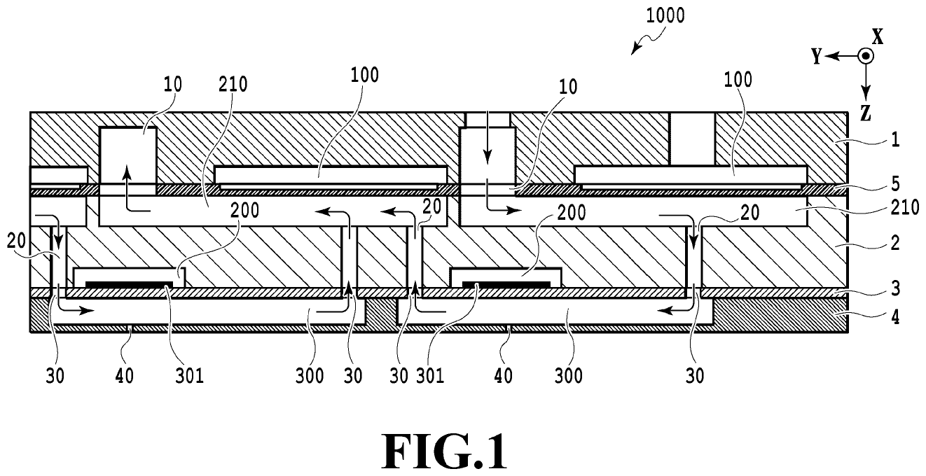

FIG. 1 is a schematic cross-sectional view of the liquid ejection head 1000 of the present disclosure. In the drawing, the X direction is the direction in which the ejection ports are arranged into an array, and corresponds to the longitudinal direction of the liquid ejection head. The Y direction is the direction in which the ejection port arrays are arranged, and corresponds to the width direction of the liquid ejection head. The Z direction is the direction of ejecting liquid.

The liquid ejection head 1000 includes the first flow path member 1, the second flow path member 2, the third flow path member 3, and the fourth flow path member 4. The flexible member 5 is installed between the first flow path member 1 and the second flow path member 2. The first flow path member 1 and the flexible member 5 are equipped with the first flow paths 10 which penetrate therethrough. The second flow path member 2 is equipped with the common liquid chamber 210 (common flow path) communicating with the first flow paths 10, the second flow paths 20, and the accommodation spaces 200 accommodating the respective piezoelectric elements 301. The third flow path member 3 is equipped with the third flow paths 30 communicating with the second flow paths 20. The third flow path member 3 includes wiring or the like for driving the piezoelectric elements 301. The fourth flow path member 4 is equipped with the pressure chambers 300 and the ejection ports 40 for ejecting ink. The pressure chambers 300 and the piezoelectric elements 301 are installed at positions corresponding to the ejection ports 40, and ink is ejected from the ejection ports 40 by driving the piezoelectric elements 301.

The liquid ejection head 1000 of the present embodiment is a liquid ejection head of an ink circulation type. The liquid flows from the first flow paths 10 into the common liquid chamber 210 for supply, passes through the second flow paths 20 and the third flow paths 30 for supply, and is carried to the pressure chambers 300 of the fourth flow path member 4. Further, the liquid is ejected from the ejection ports 40 by driving of the piezoelectric elements 301. The not-ejected liquid passes through the third flow paths 30 and the second flow paths 20 for collection, is carried to the common liquid chamber 210 for collection, and is discharged to the outside through the first flow paths 10 for collection. A plurality of the ejection ports 40 is arranged in the X direction, and each ejection port 40 corresponds to one piezoelectric element 301 and one pressure chamber 300. In the liquid ejection head 1000 of the present embodiment, two such ejection port arrays are arranged side by side in the Y direction. The common liquid chamber 210 is installed so as to commonly communicate with the plurality of ejection ports 40 and pressure chambers 300 arranged into an array in the X direction. Further, in the present embodiment, the common liquid chamber 210 for supply is installed for each ejection port array, and the common liquid chamber 210 for collection is installed so as to be common to the two ejection port arrays.

Upon the driving of each piezoelectric element 301, a pressure wave is generated around the piezoelectric element 301. This pressure wave propagates through the third flow path 30 and second flow path 20 communicating with the pressure chamber 300 to the common liquid chamber 210 located immediately above the second flow path 20. At this time, the flexible member 5 which forms a part of the walls of the common liquid chamber 210 is pushed toward the damper chamber (a hollow chamber) 100 by the pressure wave, and is deformed, so as to attenuate the pressure wave. Hereinafter, in the present disclosure, a pair of the damper chamber 100 and the flexible member 5 is collectively referred to as a damper unit. One damper unit collectively receives pressure waves generated in multiple pressure chambers 300.

The flexible member 5 mounted on a conventional liquid ejection head is often made of a uniform material and has a uniform thickness. In this case, As the thickness is decreased, the deformation amount at the time a pressure propagates to the flexible member 5 becomes larger, and thus an effect of suppressing a pressure fluctuation can be expected. However, since the flexible member 5 repeatedly undergoes the deformation over a long period of time, the portions in contact with the corner portions of the damper chamber 100 become worn and prone to tearing. If the flexible member breaks, not only is the effect of suppressing pressure fluctuations reduced, but also the liquid inside the flow paths enters the damper chamber 100, resulting in unstable ejection performance. On the other hand, increasing the thickness of the flexible member 5 in order to lower the risk of tearing associated with long-term use decreases the deformation amount as a pressure propagates to the flexible member, and thus the effect of suppressing pressure fluctuations is reduced. In this way, the challenge is to achieve both a certain level of suppression of pressure fluctuations and high durability of the flexible member.

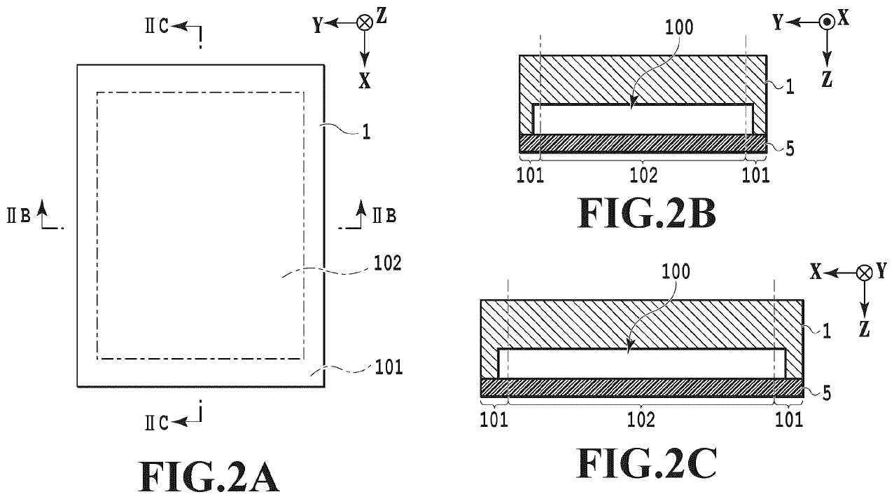

FIGS. 2A to 2C are schematic enlarged views of a conventional damper unit in general. FIG. 2A is a top view of a portion of the first flow path member 1 corresponding to a damper unit, FIG. 2B is a cross-sectional view taken along line IIB-IIB in FIG. 2A, and FIG. 2C is a cross-sectional view taken along line IIC-IIC in FIG. 2A.

The flexible member 5 formed between the first flow path member 1 and the second flow path member 2 is preferably made of a photosensitive resin that is cured by a chemical reaction. Such a member allows easy patterning and facilitates manufacturing into a liquid ejection head. A negative photosensitive resin is more preferable than a positive photosensitive resin due to the ease of enhancing chemical resistance. The flexible member 5 can be made of epoxy, acrylic, urethane, silicone, benzocyclobutene, polyimide, polyamide, polyamideimide, cyanoacrylate, phenol, melamine, styrene, cyclized rubber, or a mixture of these and the like. Among these, resins containing epoxy, silicone, benzocyclobutene, and polyimide as main components, which have excellent chemical resistance, are preferable. The type of silicone is not particularly limited, and for example, a condensation-type silicone or an addition-type silicone can be used. Among these, addition-type silicones, which have little shrinkage on curing, are preferred. For example, epoxy-modified silicone, acrylic-modified silicone, methyl-based silicone, phenyl-based silicone, methyl-phenyl-based silicone, alkyd-modified silicone, polyester-modified silicone, or a mixture of these can be used. There is no particular limitation on benzocyclobutene, and the CYCLOTENE series manufactured by Dow Inc., etc., can be used. There is no particular limitation on polyimide, and a polyimide with thermoplastic properties may be used in the form of a film, or a polyamic acid may be used as a precursor.

As illustrated in FIG. 2B and FIG. 2C, in the present disclosure, the vicinity of the corner portions of the damper chamber 100 that comes into contact with the flexible member 5 is referred to as the peripheral portion 101 of the damper chamber, and the inner side thereof is referred to as the central portion 102. The flexible member 5 is pushed toward the damper chamber 100 side (in the −Z direction) by a pressure wave generated at the time the piezoelectric element 301 is driven. Since the flexible member 5 repeatedly undergoes the displacement action, the portion located at the corner portions of the damper chamber 100 is more likely to wear out than other portions. Therefore, there is a concern that the flexible member 5 at the peripheral portion 101 may become worn, develop cracks, and eventually break.

Therefore, in the present disclosure, the breaking strength at the peripheral portion 101 of the damper chamber 100 is made higher than the breaking strength at the central portion 102 of the damper chamber 100. This allows the time period until the flexible member 5 breaks to be extended, thereby implementing a longer lifetime of the liquid ejection head. Since the breaking strength at the peripheral portion 101 of the damper chamber is made higher than that at the central portion 102, the breaking strength at the central portion 102 can be maintained at the same level as in the prior art. Accordingly, it is possible to implement appropriate flexibility, i.e., high damping performance.

### First Embodiment

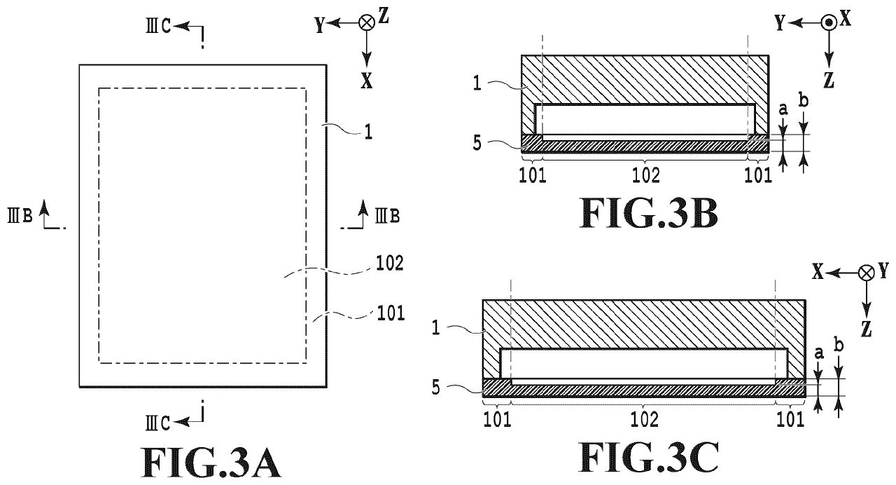

FIGS. 3A to 3C are schematic enlarged views of a damper unit of the present embodiment. FIG. 3A is a top view of a portion of the first flow path member 1 corresponding to a damper unit, FIG. 3B is a cross-sectional view taken along line IIIB-IIIB in FIG. 3A, and FIG. 3C is a cross-sectional view taken along line IIIC-IIIC in FIG. 3A.

In the present embodiment, the thickness of the flexible member 5 at the peripheral portion 101 is made thicker than that at the central portion 102, so that the breaking strength of the damper chamber 100 at the peripheral portion 101 is made higher than that at the central portion 102. Note that “breaking strength” in the present disclosure refers to a strength defined in JIS K 6251.

The thicker the flexible member 5 is, the higher its breaking strength becomes, and the flexible member 5 becomes able to withstand repeated displacement actions caused by pressure waves more. On the other hand, with an increased film thickness, the flexible member 5 becomes harder to deform and cannot sufficiently attenuate the pressures. Therefore, in the present embodiment, film thicknesses are selectively formed for the peripheral portion 101 and the central portion 102.

The flexible member 5 of the present embodiment is formed so that, if the film thickness of the peripheral portion 101 is b and the film thickness of the central portion 102 is a, then the relationship between these film thicknesses is a<b.

As a preliminary study, the present inventors confirmed that, at the time the flexible member 5 deforms due to a pressure wave generated by the driving of a piezoelectric element, the displacement amount of the flexible member in the thickness direction was 0.1 μm or less. In this case, if the film thickness of the peripheral portion 101 is thicker than that of the central portion 102 by 0.1 μm or more, the displacement amount at the central portion 102 can be limited within the range of the entire thickness of the flexible member 5, thereby suppressing the load applied to the peripheral portion 101 that abuts on the first flow path member 1. Therefore, it is possible to implement a flexible member with higher durability than a flexible member formed with a uniform film thickness.

Further, the present inventors also confirmed that, if the film thickness a of the flexible member at the central portion 102 is 2.0 μm or more, the vibration in the liquid chamber caused by pressure waves can be sufficiently suppressed, thereby preventing crosstalk and ensuring that no tearing of the flexible member 5 occurs at the central portion of the damper chamber. Furthermore, it was confirmed that the film thickness b of the peripheral portion 101 of the flexible member can be formed up to a maximum of 35.0 μm. According to this, the film thickness a of the flexible member 5 is preferably in the range of 2.0 to 5.0 μm, and the film thickness b of the flexible member 5 is preferably in the range of 2.1 to 35.0 μm. This makes it possible to implement a damper unit with high damping performance and high durability. However, the above-mentioned numeric values are merely examples. If the relationship a<b is satisfied between the film thickness a of the flexible member at the central portion 102 and the film thickness b at the peripheral portion 101, the breaking strength at the peripheral portion 101 becomes higher than that at the central portion 102, making it possible to implement both high damping performance and high durability.

### Second Embodiment

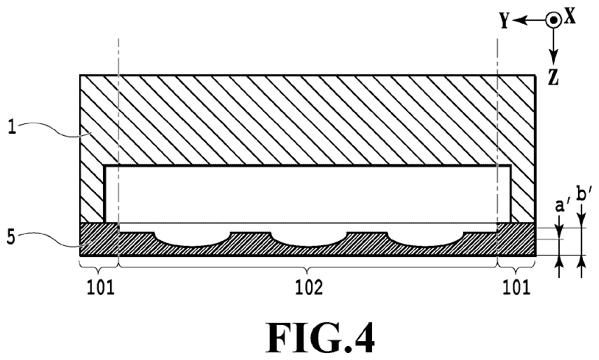

FIG. 4 is a schematic cross-sectional view of a damper unit according to the second embodiment of the present disclosure. In the present embodiment, as in the first embodiment, the thickness of the flexible member 5 at the peripheral portion 101 is made thicker than that at the central portion 102. However, unlike the first embodiment, the three recessed portions are formed in the central portion 102 of the flexible member 5. They are formed such that, if the average film thickness of the central portion 102 of the damper chamber 100 is a′ and the average film thickness of the peripheral portion 101 of the damper chamber 100 is b′, the relationship between these film thicknesses is a′<b′. Even with such a configuration, the breaking strength of the peripheral portion 101 of the damper chamber 100 can be made higher than that of the central portion 102 of the damper chamber 100, thereby implementing a damper with high damping performance and high durability.

### Modification Example

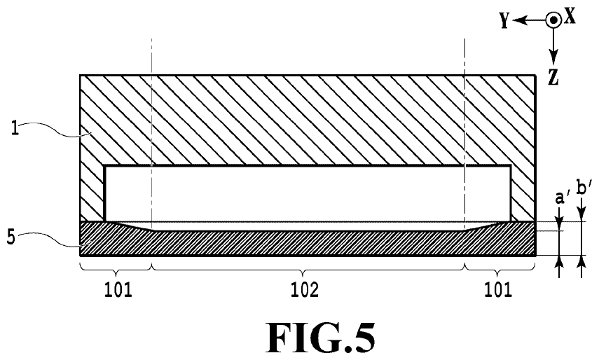

FIG. 5 is a schematic cross-sectional view illustrating a modification example of the damper unit according to the second embodiment.

As illustrated in FIG. 5, the film thickness of the peripheral portion 101 of the damper chamber 100 is not made uniform, and, within the peripheral portion 101, the portion that does not abut on the first flow path member 1 is formed to have a tapered shape in which the thickness gradually decreases toward the central portion 102. Even with such a configuration, the relationship of a′<b′ is satisfied, and thus the breaking strength of the peripheral portion 101 of the damper chamber 100 can be made higher than that of the central portion 102 of the damper chamber 100. As a result, it is possible to implement a damper with high damping performance and high durability.

Note that the depth and width of the recessed portions in FIG. 4 and the angle of the taper and the region where the taper is formed in FIG. 5 can be adjusted in any desired manner, so as to control the pressure suppression effect and the durability of the flexible member. That is, the depth and width of the recessed portions in FIG. 4 and the angle of the taper and the region where the taper is formed in FIG. 5 may vary depending on whether the common liquid chamber 210 is for supply or collection, the number of corresponding piezoelectric elements 301, the type of liquid, etc.

Note that in the present embodiment as well, the average film thickness a′ of the flexible member 5 is preferably in the range of 2.0 to 5.0 μm, and the average film thickness b′ is preferably in the range of 2.1 to 35.0 μm. This makes it possible to implement a damper unit with high damping performance and high durability.

### Third Embodiment

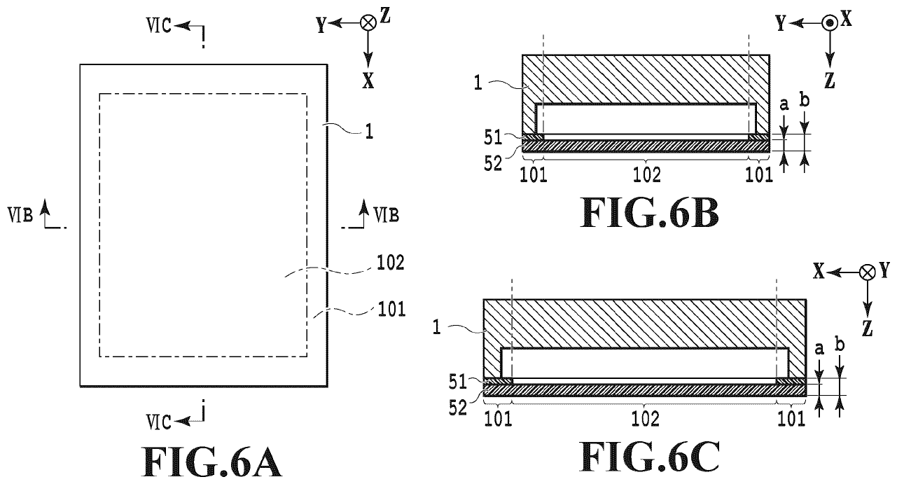

FIGS. 6A to 6C are schematic views illustrating a damper unit according to the third embodiment of the present disclosure.

As illustrated in FIG. 6B and FIG. 6C, the flexible member of the present embodiment is formed of two different materials, i.e., the first flexible member 51 and the second flexible member 52. The peripheral portion 101 is formed of the first flexible member 51 and the second flexible member 52, and the central portion 102 is formed of the second flexible member 52. The second flexible member 52 has a uniform thickness over the entire damper unit. Accordingly, the breaking strength of the damper chamber 100 at the peripheral portion 101 is made higher than that at the central portion 102 of the damper chamber 100, thereby implementing high damping performance and high durability. Note that the first flexible member 51 and the second flexible member 52 may each be made of an appropriately selected material. However, for the first flexible member 51, it is preferable to select a material with higher breaking strength than that of the second flexible member 52.

The first flexible member 51 can be made of epoxy, acrylic, urethane, silicone, benzocyclobutene, polyimide, polyamide, polyamideimide, cyanoacrylate, phenol, melamine, styrene, cyclized rubber, or a mixture of these and the like. Further, the second flexible member 52 can be made of epoxy, acrylic, urethane, silicone, benzocyclobutene, polyimide, polyamide, polyamideimide, cyanoacrylate, phenol, melamine, styrene, cyclized rubber, or a mixture of these and the like. Among these, resins containing epoxy, silicone, benzocyclobutene, or polyimide as a main component, which have excellent chemical resistance, are preferable for both of the first flexible member 51 and the second flexible member 52.

The thicker the flexible member is, the higher its breaking strength becomes, and the flexible member 5 becomes able to withstand repeated displacement actions caused by pressure waves more. On the other hand, with an increased film thickness, the flexible member 5 may become harder to deform and cannot sufficiently attenuate the pressures. Therefore, it is preferable that the thicknesses of the first flexible member 51 and the second flexible member 52 are appropriately adjusted.

According to the study by the inventors, it was confirmed that, even in the present embodiment, a film thickness a of the flexible member is preferably in the range of 2.0 to 5.0 μm, and a film thickness b is preferably in the range of 2.1 to 35.0 μm. By adjusting the thicknesses of the first flexible member 51 and the second flexible member 52 so as to achieve film thicknesses within these ranges, it is possible to implement a damper unit with high damping performance and high durability.

Note that, although the above describes a case in which the flexible member 5 is formed of the two materials, i.e., the first flexible member 51 and the second flexible member 52, it is also possible that the flexible member 5 is formed of three or more materials.

### Fourth Embodiment

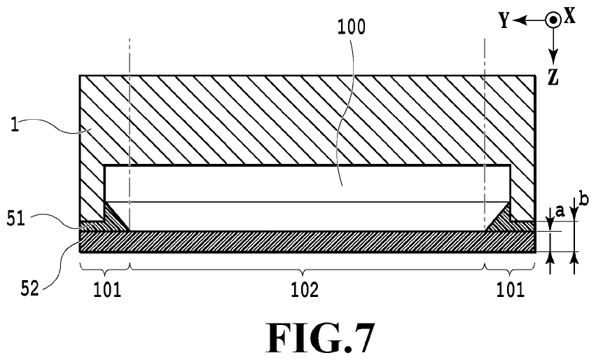

FIG. 7 is a schematic cross-sectional view illustrating a damper unit according to the fourth embodiment of the present disclosure.

In the present embodiment, as in the third embodiment, the flexible member includes the first flexible member 51 and the second flexible member 52. However, the first flexible member 51 according to the fourth embodiment is partially in contact with the inner wall of the damper chamber 100 as illustrated in FIG. 7. In this way, the contact area between the first flexible member 51 and the first flow path member 1 becomes large, and thus the pressure applied to the portion of the flexible member 5 in contact with the first flow path member 1 at the time of displacement can be dispersed. Thus, it is possible to prevent the load from concentrating locally on the flexible member 5, suppress wearing on the surface of the flexible member caused by repeated displacement actions, and extend the lifetime of the damper unit.

In the present embodiment, the first flexible member 51 may also function as an adhesive agent. In this case, the thickness (b-a) of the first flexible member 51 is preferably in the range of 0.1 to 30.0 μm. Further, the width of the thick film portion of the peripheral portion 101 is preferably in the range of 0.1 to 20 μm. It is sufficient that, as a result of the bonding process between the uncured adhesive agent and the second flexible member 52, the adhesive agent protruding to the inside of the damper chamber becomes the first flexible member 51 with a width region of 0.1 to 20 μm. With such a configuration, at the time of displacement actions of the flexible member, the second flexible member 52 does not come into direct contact with the corner portions of the first flow path member 1 forming the damper chamber 100, thereby suppressing the concern that the second flexible member 52 may break.

### Fifth Embodiment

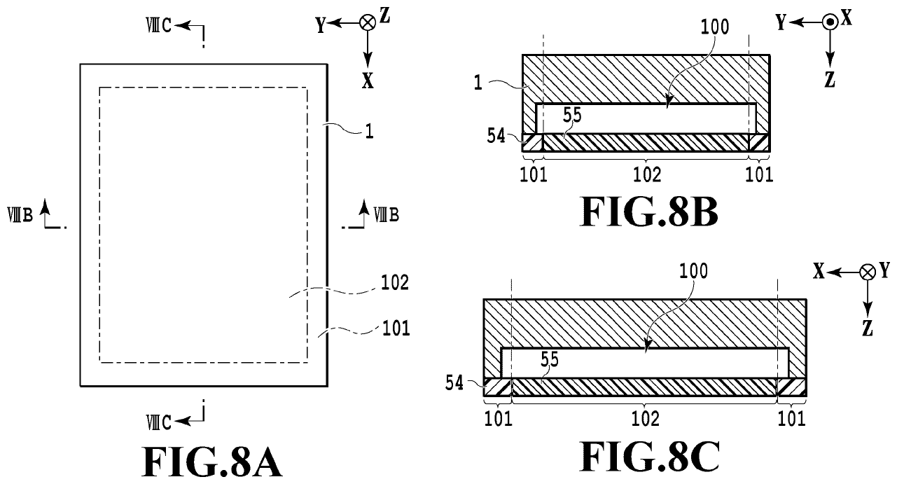

FIGS. 8A to 8C are schematic views illustrating a damper unit according to the fifth embodiment of the present disclosure.

As illustrated in FIG. 8B and FIG. 8C, the flexible member of the present embodiment is formed of the two materials in a planar direction orthogonal to the thickness direction, i.e., the third flexible member 54 arranged as the peripheral portion 101 and the fourth flexible member 55 arranged as the central portion 102. The breaking strength of the third flexible member 54 is higher than that of the fourth flexible member 55. Accordingly, the breaking strength of the damper chamber 100 at the peripheral portion 101 is made higher than that at the central portion 102 of the damper chamber 100, thereby implementing a damper unit with high damping performance and high durability.

By selecting appropriate materials for each of the third flexible member 54 and the fourth flexible member 55, it is possible to further improve the damping effect and durability. By selecting appropriate materials for the third flexible member 54 and the fourth flexible member 55 and adjusting the film thicknesses and the protruding width of the third flexible member 54 into the damper chamber, it is possible to achieve both durability and damping performance of the flexible members. Although, in the drawings, the form in which the third flexible member 54 and the fourth flexible member 55 have the same film thickness is illustrated, if the film thickness of the third flexible member 54 is made thicker than that of the fourth flexible member 55, higher damping performance and higher durability can be expected.

Note that, although the above describes a case in which the flexible member 5 is formed of the two materials, i.e., the third flexible member 54 and the fourth flexible member 55, it is also possible that the flexible member 5 is formed of three or more materials.

### (Manufacturing Method of the Damper Unit)

### Exemplary Embodiment of the First Embodiment

For the liquid ejection head of the first embodiment, the first flow path member 1 was formed of silicon, the second flow path member 2 was formed of silicon, and the flexible member 5 was formed of benzocyclobutene.

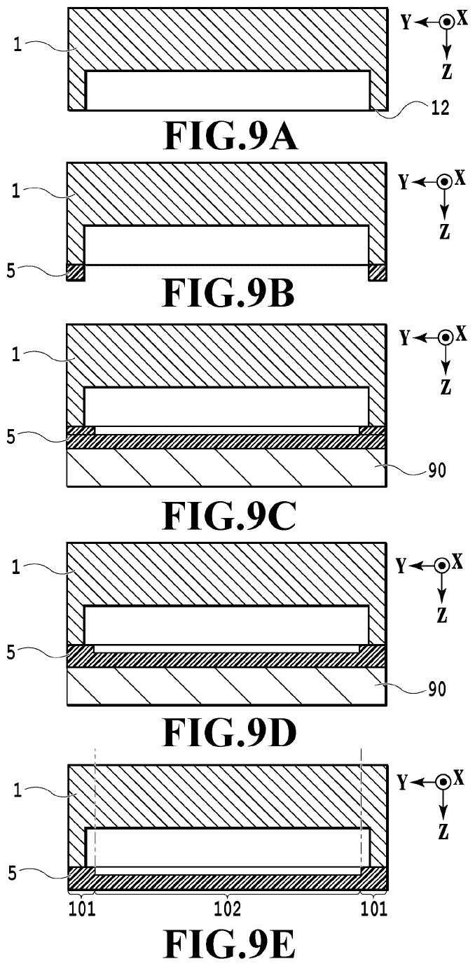

FIGS. 9A to 9E are diagrams illustrating a manufacturing method of the damper unit according to the first embodiment. The damper unit is formed as a part of the liquid ejection head 1000 at the time of manufacturing the liquid ejection head 1000. The processes illustrated in FIGS. 9A to 9E indicate a part of the manufacturing process of the liquid ejection head 1000, focusing on the damper unit.

However, the description with reference to FIGS. 9A to 9E is merely a technically preferred example. The technical scope of the present disclosure is not particularly limited.

First, a 625 μm silicon substrate was prepared, and a positive photoresist was exposed and developed on both surfaces of this silicon substrate. Thereafter, the first flow path member 1 with a recessed portion to serve as the damper chamber 100 was formed by dry etching, as illustrated in FIG. 9A.

Next, as illustrated in FIG. 9B, the uncured flexible member 5 with a thickness of 2 μm was made into a dry film and transferred to the outer peripheral surface 12 of the first flow path member. In the present exemplary embodiment, benzocyclobutene, which is a thermosetting resin, was applied as the flexible member 5.

Next, benzocyclobutene with a thickness of 3 μm was applied to the support substrate 90, which is flat and smooth. The support substrate 90 used here is made of silicon, similarly to the first flow path member 1. Then, as illustrated in FIG. 9C, the support substrate 90 and the first flow path member 1 were attached to each other with the surface to which benzocyclobutene was applied facing the uncured thermosetting resin, and bonded together under application of pressure.

Next, heating was performed at 250° C. using an oven. Thereby, the material applied to the first flow path member 1 side and the material applied to the support substrate 90 side were bonded together as illustrated in FIG. 9D, and thus the flexible member 5 was formed between the first flow path member 1 and the support substrate 90. Furthermore, as illustrated in FIG. 9E, the support substrate 90 was completely removed by polishing and dry etching until the surface of the flexible member 5 was exposed.

### Exemplary Embodiment of the Second Embodiment

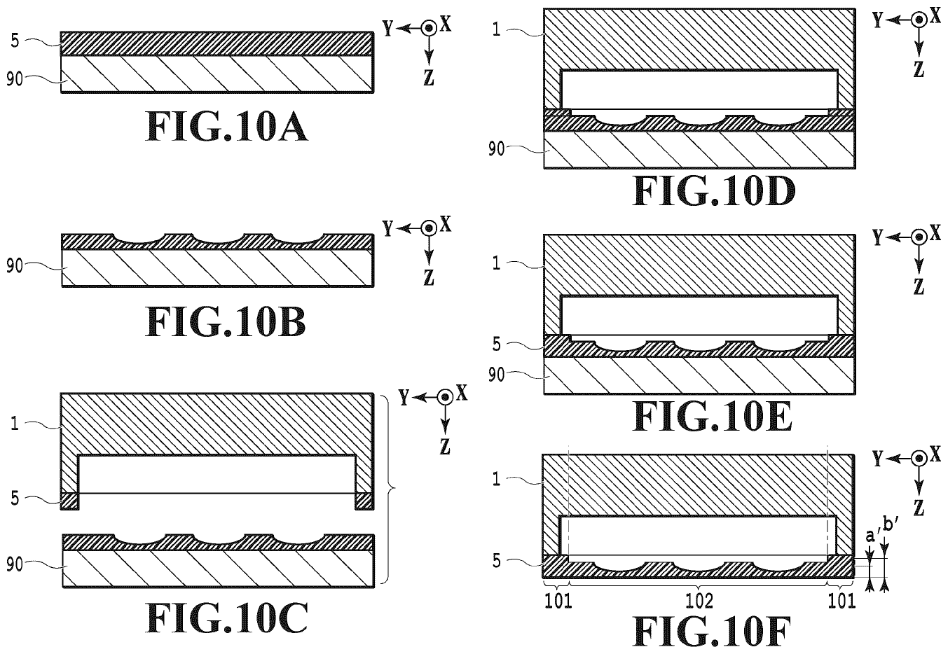

FIGS. 10A to 10F are diagrams illustrating a manufacturing method of the damper unit according to the second embodiment illustrated in FIG. 4.

Since the processes up to applying the material that forms a part of the flexible member 5 to the first flow path member 1 are the same as those illustrated in FIGS. 9A and 9B, and thus a description thereof is omitted here. Note that the description with reference to FIGS. 10A to 10F is merely a technically preferred example. The technical scope of the present disclosure is not particularly limited.

As illustrated in FIG. 10A, as in the first embodiment, benzocyclobutene with a thickness of 3 μm was applied to the support substrate 90. Thereafter, as illustrated in FIG. 10B, patterning and dry etching were repeated multiple times to form the wavellike shape in the benzocyclobutene layer.

Next, as illustrated in FIG. 10C, the surface to which benzocyclobutene was applied was placed so as to face the uncured thermosetting resin applied to the first flow path member 1. Then, as illustrated in FIG. 10D, the support substrate 90 and the first flow path member 1 were attached to each other and bonded together under application of pressure.

Next, heating was performed at 250° C. using an oven. Thereby, the material applied to the first flow path member 1 side and the material applied to the support substrate 90 side were bonded together and cured as illustrated in FIG. 10E. Furthermore, as illustrated in FIG. 10F, the support substrate 90 was completely removed by polishing and dry etching until the surface of the flexible member 5 was exposed.

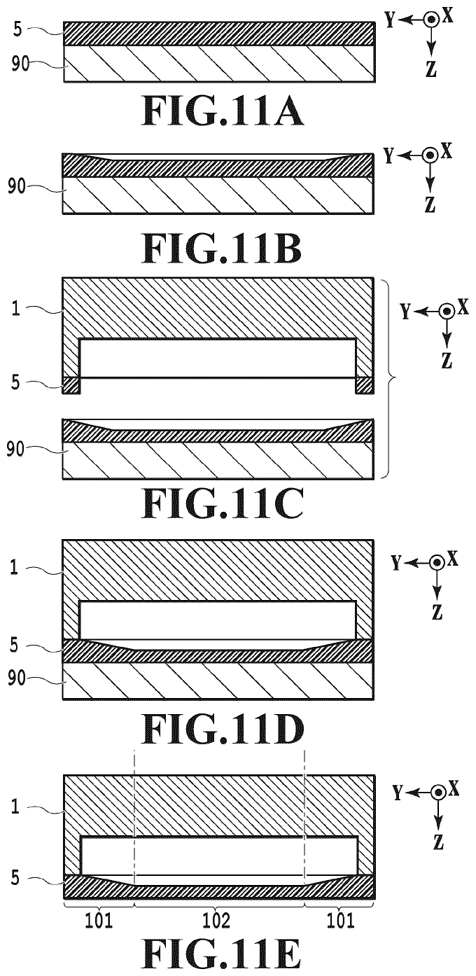

FIG. 11A to FIG. 11E are diagrams illustrating a manufacturing method of the damper unit according to the second embodiment illustrated in FIG. 5. Similarly to the above, the damper unit illustrated in FIG. 5, which has a structure whose surface of the flexible member 5 has a tapered shape, can also be formed by carrying out the same processing procedure.

### Exemplary Embodiment of the Third Embodiment

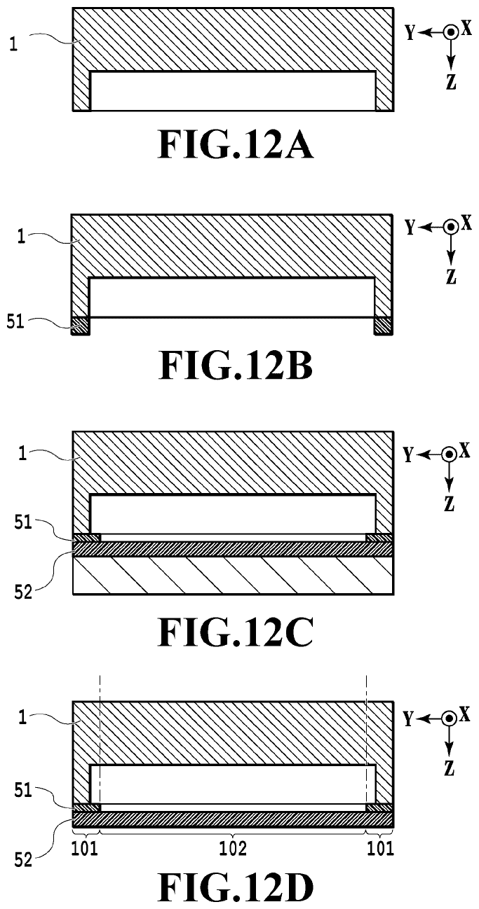

FIGS. 12A to 12D are diagrams illustrating a manufacturing method of the damper unit according to the third embodiment.

However, the description with reference to FIGS. 12A to 12D is merely a technically preferred example. The technical scope of the present disclosure is not particularly limited.

First, a 625 μm silicon substrate was prepared, and a positive photoresist was exposed and developed on both surfaces of this silicon substrate. Thereafter, the first flow path member 1 with a recessed portion to serve as the damper chamber 100 was formed by dry etching, as illustrated in FIG. 12A.

Next, as illustrated in FIG. 12B, the uncured adhesive agent with a thickness of 2 μm was made into a dry film and transferred to the outer peripheral surface of the first flow path member. In the present exemplary embodiment, a thermosetting resin, which is a material different from benzocyclobutene, is applied as the adhesive agent. This adhesive agent becomes the first flexible member 51.

Next, as in the first embodiment, the support substrate 90 to which benzocyclobutene was applied with a thickness of 3 μm was prepared. This benzocyclobutene layer becomes the second flexible member 52. Then, as illustrated in FIG. 12C, the support substrate 90 was attached to the first flow path member 1 with the surface to which benzocyclobutene was applied facing the uncured adhesive agent, and bonded together under application of pressure.

Next, heating was performed at 250° C. using an oven, and thus the first flexible member 51 and the second flexible member 52 were cured. Furthermore, as illustrated in FIG. 12D, the support substrate 90 was completely removed by polishing and dry etching until the surface of the flexible member 5 was exposed.

### Exemplary Embodiment of the Fourth Embodiment

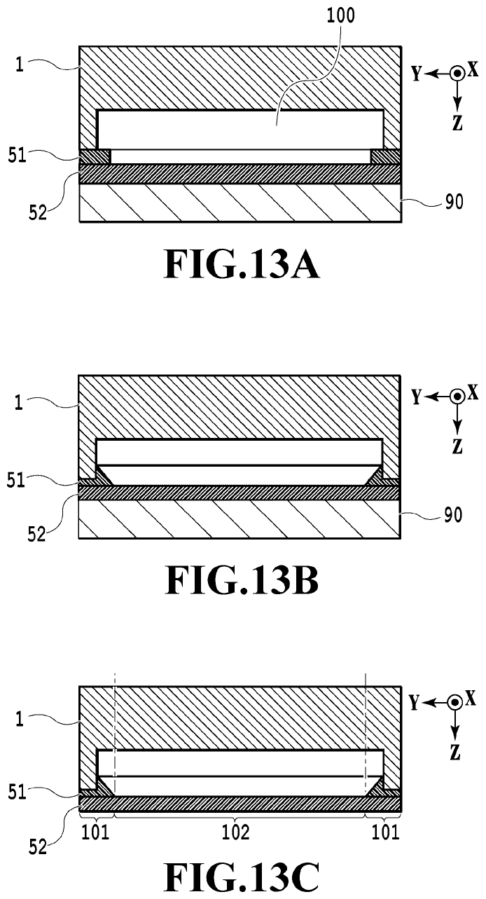

FIGS. 13A to 13C are diagrams illustrating a manufacturing method of the damper unit according to the fourth embodiment.

However, the description with reference to FIGS. 13A to 13C is merely a technically preferred example. The technical scope of the present disclosure is not particularly limited.

In the present exemplary embodiment, the manufacturing method is almost the same as that of the third exemplary embodiment described with reference to FIG. 12A to FIG. 12D. However, in the present exemplary embodiment, a positive photoresist was exposed and developed on the first flow path member 1, and the first flow path member 1 was formed by dry etching, and then plasma ashing was performed on the inner wall of the damper chamber 100 to improve wettability.

Then, as illustrated in FIG. 13A, the support substrate 90 was brought into contact with the first flow path member 1 with the surface to which the second flexible member 52 was applied facing the uncured first flexible member 51. Furthermore, the two were bonded together under application of pressure, so that, as illustrated in FIG. 13B, the uncured first flexible member 51 was brought into contact with the inner wall of the damper chamber 100.

Next, heating was performed at 250° C. using an oven, and thus the first flexible member 51 and the second flexible member 52 were cured. Furthermore, as illustrated in FIG. 13C, the support substrate 90 was completely removed by polishing and dry etching until the surface of the flexible member 5 was exposed.

Note that, upon inspection of the cured damper unit, it was confirmed that the first flexible member 51 reached a height of 30 μm in the vertical direction from the interface with the second flexible member 52.

### Exemplary Embodiment of the Fifth Embodiment

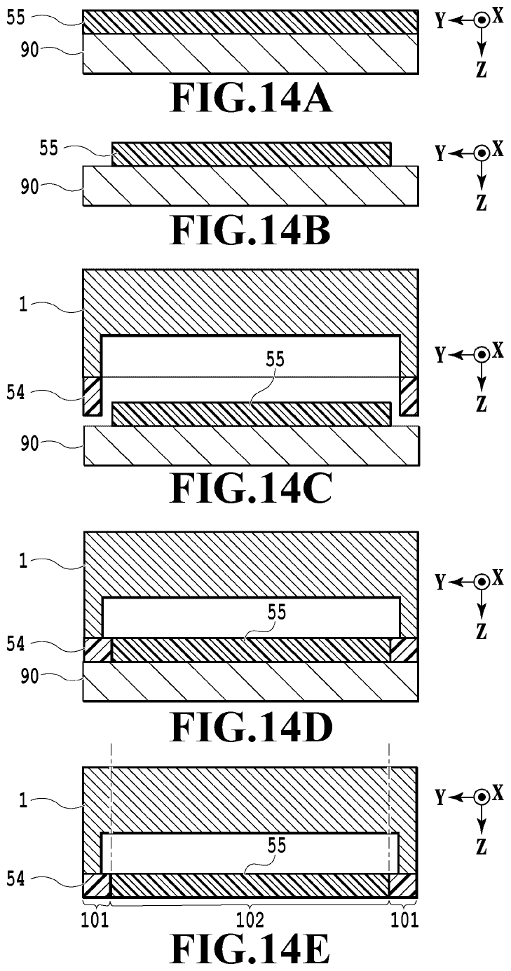

FIGS. 14A to 14E are diagrams illustrating a manufacturing method of the damper unit according to the fifth embodiment.

However, the description with reference to FIGS. 14A to 14E is merely a technically preferred example. The technical scope of the present disclosure is not particularly limited.

Since the processes up to applying the material that forms a part of the flexible member 5 to the first flow path member 1 are the same as those illustrated in FIG. 12A and FIG. 12B, and thus a description thereof is omitted here. The material applied to the first flow path member 1 becomes the third flexible member 54 in the present exemplary embodiment. In the present exemplary embodiment, a thermosetting resin is applied as the third flexible member 54.

As illustrated in FIG. 14A, the support substrate 90 to which the fourth flexible member 55 was applied was prepared. Here, benzocyclobutene with a thickness of 3 μm was used for the fourth flexible member 55.

Next, as illustrated in FIG. 14B, patterning and dry etching were performed as the process of removing the outer peripheral region of the fourth flexible member 55 until the surface of the support substrate 90 was exposed. The size (width) of the outer peripheral region to be removed was such that, in the bonding process which is described next, the third flexible member 54 and the fourth flexible member 55 do not overlap in the bonding direction (Z direction).

Next, as illustrated in FIG. 14C, the first flow path member to which the third flexible member 54 was applied was placed so as to face the support substrate 90 which has the fourth flexible member 55 thereon. Furthermore, these were attached to each other and bonded together under application of pressure. At this time, as illustrated in FIG. 14D, the third flexible member 54 expands in the planar direction due to the bonding pressure, and comes into contact with the side surface of the fourth flexible member 55.

Next, heating was performed at 250° C. using an oven, and thus the third flexible member 54 and the fourth flexible member 55 were cured. Furthermore, as illustrated in FIG. 14E, the support substrate 90 was completely removed by polishing and dry etching until the surface of the flexible member 5 was exposed.

By using the methods in the manner described above, it is possible to manufacture a liquid ejection head equipped with a damper unit with high damping performance and high durability.

### Other Embodiments

Although the above description is given using an example of a circulation type liquid ejection head as described with reference to FIG. 1, the liquid ejection head of the present disclosure is not limited to this. A non-circulation type liquid ejection head with a common liquid chamber and flow paths only for supply may also be used. Further, although the piezoelectric elements 301 are used to eject ink in the above embodiments, the present disclosure is not limited to this, and heaters that generate bubbles by film boiling may also be used.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145481, filed Aug. 27, 2024, which is hereby incorporated by reference herein in its entirety.

What is claimed is:

1. A liquid ejection head comprising:
a plurality of ejection ports for ejecting liquid;
a plurality of pressure chambers configured to communicate with the plurality of ejection ports, respectively;
a plurality of pressure generating units installed in the plurality of pressure chambers, respectively, and configured to generate pressure for ejecting the liquid from the ejection ports;
a common flow path configured to commonly communicate with the plurality of pressure chambers;
a flexible member configured to form a part of a wall surface of the common flow path and configured to be deformable in accordance with pressure fluctuation occurring in the plurality of pressure chambers; and
a hollow chamber arranged at a position facing the common flow path via the flexible member,
wherein, of the flexible member, a breaking strength at a peripheral portion in the hollow chamber is higher than a breaking strength at a central portion in the hollow chamber.

2. The liquid ejection head according to claim 1,
wherein a film thickness at the peripheral portion of the flexible member is greater than a film thickness at the central portion of the flexible member.

3. The liquid ejection head according to claim 1,
wherein a thickness of the peripheral portion or the central portion of the flexible member is not uniform, and
wherein an average film thickness at the peripheral portion is greater than an average film thickness at the central portion.

4. The liquid ejection head according to claim 3,
wherein the flexible member is formed in a tapered shape from the central portion toward the peripheral portion.

5. The liquid ejection head according to claim 3,
wherein a recessed portion is formed in the central portion of the flexible member.

6. The liquid ejection head according to claim 1,
wherein, in the flexible member, the central portion is formed of a first flexible member, and the peripheral portion is formed by stacking the first flexible member and a second flexible member.

7. The liquid ejection head according to claim 6,
wherein a breaking strength of the first flexible member is higher than a breaking strength of the second flexible member.

8. The liquid ejection head according to claim 6,
wherein the first flexible member is in contact with a part of an inner wall of the hollow chamber.

9. The liquid ejection head according to claim 1,
wherein the central portion is formed of a third flexible member, and the peripheral portion is formed of a fourth flexible member having a breaking strength higher than that of the third flexible member.

10. The liquid ejection head according to claim 1,
wherein the flexible member is made of any one or a mixture of two or more of epoxy, acrylic, urethane, silicone, benzocyclobutene, polyimide, polyamide, polyamide-imide, cyanoacrylate, phenol, melamine, styrene, and cyclized rubber.

11. A method for manufacturing a damper unit for a liquid ejection head, the method comprising:
applying a first material to a peripheral portion of a flow path member having a recessed portion, the peripheral portion surrounding the recessed portion;
applying a second material to a surface of a flat and smooth support substrate;
bonding the first material and the second material such that the surface to which the first material has been applied on the flow path member faces the surface to which the second material has been applied on the support substrate; and
curing the first material and the second material by heating.

12. The method for manufacturing a damper unit for a liquid ejection head according to claim 11 further comprising
removing the support substrate after the curing.

13. The method for manufacturing a damper unit for a liquid ejection head according to claim 11,
wherein the first material and the second material are the same material.

14. The method for manufacturing a damper unit for a liquid ejection head according to claim 11,
wherein the first material and the second material are different materials.

15. The method for manufacturing a damper unit for a liquid ejection head according to claim 14,
wherein a breaking strength of the first material after the curing is higher than a breaking strength of the second material after the curing.

16. The method for manufacturing a damper unit for a liquid ejection head according to claim 11,
wherein, after the applying of the second material, a recessed portion is formed on the surface to which the second material has been applied.

17. The method for manufacturing a damper unit for a liquid ejection head according to claim 11,
wherein, in the bonding, a part of the first material before the curing moves into the recessed portion.

18. The method for manufacturing a damper unit for a liquid ejection head according to claim 11 further comprising
removing a region of the second material, which has been applied to the support substrate, from the support substrate after the applying of the second material, the region corresponding to the peripheral portion,
wherein, in the bonding, the first material and the second material are bonded in a direction intersecting with a direction in which the flow path member and the support substrate face each other.

19. The method for manufacturing a damper unit for a liquid ejection head according to claim 11,
wherein the flow path member is silicon.

20. The method for manufacturing a damper unit for a liquid ejection head according to claim 11,
wherein each of the first material and the second material is made of any one or a mixture of two or more of epoxy, acrylic, urethane, silicone, benzocyclobutene, polyimide, polyamide, polyamide-imide, cyanoacrylate, phenol, melamine, styrene, and cyclized rubber.
